(19) United States
(12) Patent Application Publication
(10) Pub. No.: US 2019/0036720 A1
(43) Pub. Date: Jan. 31, 2019

(54) METHOD AND DEVICE TO SELECT AN ELECTRONIC DEVICE BASED ON DELIVERY ATTRIBUTES

(71) Applicant: Lenovo (Singapore) Pte. Ltd., New Tech Park (SG)

(72) Inventors: Ryan Charles Knudson, Durham, NC (US); Russell Speight VanBlon, Raleigh, NC (US); Roderick Echols, Chapel Hill, NC (US); Jonathan Gaither Knox, Morrisville, NC (US)

(21) Appl. No.: 15/664,006

(22) Filed: Jul. 31, 2017

(51) Int. Cl. H04L 12/18

(52) U.S. Cl. CPC H04L 12/1895

(57) ABSTRACT

A computer implemented method, device and computer program device are provided that are under the control of one or more processors having instructions. The method, device, and system identifies a communication event and a delivery attribute associated with the communication event, identifies electronic devices available to provide a notification alert, selects at least one of the electronic devices based on the delivery attribute, generates the notification alert based on the communication event, communicates the notification alert to the at least one of the electronic devices selected.

### BACKGROUND

Embodiments herein generally relate to methods and devices for selecting an electronic device based on delivery attributes.

In today's technology driven society, many users own multiple electronic devices that can be used for different types of communications, different tasks, and/or at different locations. For example, a user may own a smart television, an audio system, a computer, home automation devices, and/or a digital personal assistant (DPA) for use at home. In addition, the user may own additional portable electronic devices for use in other locations or environments, such as smart phones, tablets, and/or smart watches.

When using multiple electronic devices, users may not reliably be notified of all communications. While many electronic devices provide notifications to alert users of communication events, the user may not receive these notification alerts for a variety of reasons. For example, the user may not be in the same location as the electronic device, or the electronic device may be in a sleep mode, restricted access mode, or turned off. In another example, the user may be in an environment that distracts the user or impedes receipt of the notification, such as an entertainment venue or work environment.

Generally, a DPA is an electronic device with a user interface that simulates human traits that allows a human user to interact with the electronic device in a manner similar to interacting with another person, rather than a machine. For example, the DPA may include a voice recognition system that interprets the voice input of the user and executes services or perform tasks in response thereto. The DPA also includes a voice interface to audibly respond to the user in a natural language form. Typically, a DPA operates on a single device with dedicated components to interact with the user. For example, the DPA may have a built-in microphone to receive user requests and a built-in speaker to provide communications. In addition, the DPA can include a component interface that can connect to wired or wireless electronic devices, such as smart phones, smart televisions, tablets, smart watches, and speakers to communicate content. However, conventional DPA's cannot administer and relay notification alerts from one electronic device to a different electronic device based on delivery attributes.

Accordingly, a need remains for methods and devices to monitor electronic devices and manage notification alerts in connection with communication events.

### SUMMARY

In accordance with embodiments herein, a method is provided. The method is under control of one or more processors configured with executable instructions to identify a communication event and a delivery attribute associated with the communication event, identify electronic devices available to provide a notification alert, select at least one of the electronic devices based on the delivery attribute, generate the notification alert based on the communication event, and communicate the notification alert to the at least one of the electronic devices selected.

Optionally, at least a portion of the identifying, selecting, generating and communicating is performed by a digital personal assistant (DPA) device. The method may determine the delivery attribute based on a presence of non-users within a predetermined range of the DPA device. The method may determine the delivery attribute based on a characteristic of an environment that the user is located, or proximity of the user to the DPA device. The method may determine the delivery attribute based on a characteristic of a user environment that impedes detection of the notification alert. The method may determine the delivery attribute based on one or more of a user history or user settings maintained at the DPA device. The method may determine the delivery attribute based on status conditions of the electronic devices. The method may determine a priority list of the electronic devices based on the delivery attribute, and select a priority electronic device from the priority list based on the delivery attribute.

In accordance with embodiments herein, a DPA device is provided comprising a processor, a user interface, and a data storage device having executable instructions accessible by the processor. Responsive to execution of the instructions, the processor identifies a communication event and a delivery attribute associated with the communication event, identifies electronic devices available to provide a notification alert, selects at least one of the electronic devices based on the delivery attribute, generates the notification alert based on the communication event, and communicates the notification alert from the DPA device to the at least one of the electronic devices.

Optionally, the DPA device may determine the delivery attribute based on a characteristic of an environment that the user is located, or proximity of the user to the DPA device. The DPA device may determine the delivery attribute based on a characteristic of a user environment that impedes detection of the notification alert. The DPA device may determine the delivery attribute based on a user history or user settings maintained at the DPA device. The DPA device may determine the delivery attribute based on status conditions of the electronic devices. The DPA device may determine a priority list of the electronic devices based on the delivery attribute, and select a priority electronic device from the priority list based on the delivery attribute.

In accordance with embodiments herein, a DPA device comprises executable code to identify a communication event and a delivery attribute associated with the communication event, identify a delivery attribute associated with one or more of the communication events, identify electronic devices available to provide a notification alert, select at least one of the electronic devices based on the delivery attribute, generate the notification alert based on the communication event, and communicate the notification alert from the DPA device to the at least one of the electronic devices.

Optionally, the DPA device may comprise executable code to determine the delivery attribute based on a characteristic of an environment that the user is located, or proximity of the user to the DPA device. The DPA device may comprise executable code to determine the delivery attribute based on a characteristic of a user environment that impedes detection of the notification alert. The DPA device may comprise executable code to determine the delivery attribute based on one or more of a user history or user settings maintained at the DPA device. The DPA device may comprise executable code to determine the delivery attribute based on status conditions of the electronic devices. The DPA device may comprise executable code to determine a priority list of the electronic devices based on the delivery attribute and select a priority electronic device from the priority list based on the delivery attribute.

### BRIEF DESCRIPTION OF THE DRAWINGS

FIG. 1 illustrates a system for selecting an electronic device based on delivery attributes in accordance with embodiments herein.

FIG. 2 illustrates a process for selecting an electronic device based on a delivery attribute associated with a communication event in accordance with embodiments herein.

FIG. 3 illustrates a process for identifying a delivery attribute associated with the communication event in accordance with embodiments herein.

### DETAILED DESCRIPTION

It will be readily understood that the components of the embodiments as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, appearances of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, etc. In other instances, well-known structures, materials, or operations are not shown or described in detail to avoid obfuscation. The following description is intended only by way of example, and simply illustrates certain example embodiments.

The term “communication event” as used throughout, shall generally refer to any type of communication supported by electronic devices and/or electronic accounts. For example, a communication event may correspond to an electronic mail message, a text message, a phone call, a social media message, as well as any general type of communication conveying documents, audio content, video content, or other electronic content to a destination address.

The term “communication content” as used throughout, shall generally refer to any and all textual, audio or video information or data conveyed to or from a device during a communication event. The communication content may be as simple as a telephone number for an incoming or outgoing phone call, or may be more extensive, such as the complete data content (including addressing headers) for an individual or string of email messages, text messages and the like. The communication content may include notes, task information, text messages, email messages, picture(s), audio, video and media files.

The term “notification alert” as used throughout, shall generally refer to a transmission conveyed to a device to notify a user of a communication event. The notification alert includes, but is not limited to text communication, audio tone, natural language communication, an image, a light, and the like.

The term “notification content” as used throughout, shall generally refer to any and all textual, audio, or video information or data conveyed to or from a device in connection with a notification alert. The notification content may be as simple as a telephone number for an incoming or outgoing phone call, or may be more extensive, such as the complete data content (including addressing headers) for an individual or string of email messages, text messages, and the like. The notification content may include notes, task information, text messages, email messages, picture(s), audio, video and media files.

The term “digital personal assistant”, “DPA”, “virtual assistant”, “intelligent digital assistant”, as used throughout, shall generally refer to any electronic device that has a user interface or information processing system that uses a voice recognition system, such as a Natural language understanding (NLU), automatic speech recognition (ASR), or text-to-speech synthesis (TTS), to interpret natural language input in spoken form and/or textual form to infer intent, and perform actions based on an inferred user intent. For example, a digital personal assistant may receive a user request in the form of a natural language command, request, statement, narrative, and/or inquiry. A user request may seek either an informational answer or performance of a task by the digital personal assistant. Accordingly, the digital personal assistant can perform the requested task and/or provide responses in audio and/or visual form, such as natural language, music, video, text, animations, etc.

The term “delivery attribute” as used throughout, shall refer to i) characteristics associated with one or both of communications events and/or communications content; and/or ii) characteristics of a notification alert. Nonlimiting examples of delivery attributes that relate to characteristics of communications events/content include work content, confidential content, mature content, personal content, family content, public content and the like. Nonlimiting examples of delivery attributes that relate to characteristics of a notification alert include a presence of nonusers within a predetermined range of an electronic device to provide the notification output, a proximity of a user to the electronic device to provide the notification output, and environment surrounding the user that may affect the user's ability to detect the notification alert.

It should be clearly understood that the various arrangements and processes broadly described and illustrated with respect to the Figures, and/or one or more individual components or elements of such arrangements and/or one or more process operations associated of such processes, can be employed independently from or together with one or more other components, elements and/or process operations described and illustrated herein. Accordingly, while various arrangements and processes are broadly contemplated, described and illustrated herein, it should be understood that they are provided merely in illustrative and non-restrictive fashion, and furthermore can be regarded as but mere examples of possible working environments in which one or more arrangements or processes may function or operate.

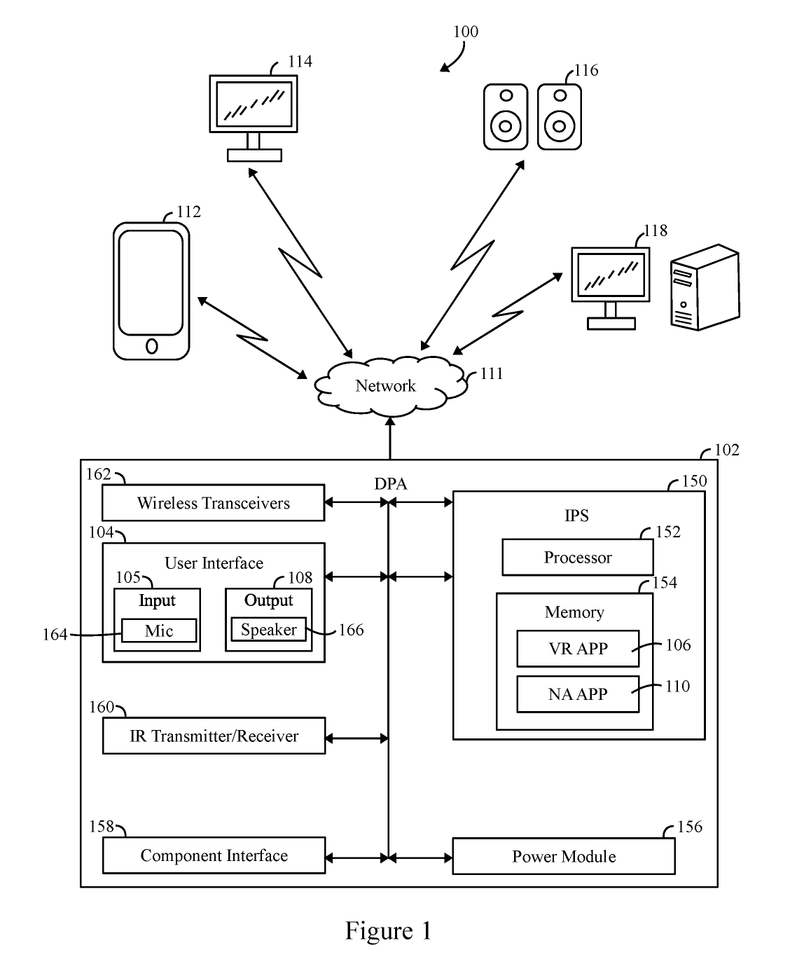

FIG. 1 illustrates a system 100 for selecting an electronic device based on delivery attributes in accordance with embodiments herein. The system 100 includes a digital personal assistant (DPA) device 102 (e.g. the Amazon Echo® device, Google Home™ device, etc.) with a user interface 104 having an input circuit 105 for a user to submit user requests using a voice recognition (VR) application 106. The DPA device 102 includes an information processing system (IPS) 150 that has one or more processors 152 and memory 154. The processors 152 execute instructions stored in the memory 154 to interpret and perform actions based on user requests that are received through the input circuit 105. A notification administration (NA) application 110 identifies communication events and communication content associated with the communication events for one or more electronic devices, 112, 114, 116, and network resources 118. The DPA device 102 also includes an output 108 to output notification alerts and notification content responsive to the communication events. A network 111 operatively connects the DPA device 102 to one or more electronic devices 112, 114, 116 and network resources 118. Based on a set of delivery attributes, the DPA device 102 determines a priority list of the electronic devices 112, 114, 116, and output 108. The DPA device 102 selects one or more (prioritized) electronic devices 112, 114, 116, and output 108 from the list, and communicates notification alerts and notification content to the selected one or more (prioritized) electronic devices 112, 114, 116 and output 108.

As explained in accordance with embodiments herein, the NA application 110 of the DPA device 102 identifies communication events in which communication content is received by or sent from at least one of the electronic devices 112, 114, 116 or the network resource 118. For example, the communication content can be any or all textual, audio or video information or data conveyed to or from a device during a communication event. The communication content may be as simple as a telephone number for an incoming or outgoing phone call, or may be more extensive, such as the complete data content (including addressing headers) for an individual or string of email messages, text messages, calendar and event reminders, task information, media files, and the like.

The DPA device 102 includes a voice recognition type user interface 104 and is configured to access the network 111 over a wired or wireless connection. As non-limiting examples, the DPA device 102 may access the network 111 through a wireless communications channel and/or through a network connection (e.g. the Internet). Additionally or alternatively, the DPA device 102 may be a wired or wireless communication terminal, such as a desktop computer, laptop computer, network-ready television, set-top box, and the like.

In the embodiment of FIG. 1, the electronic devices are illustrated as a smart phone 112, a smart television 114, and wireless speakers 116. However, one or more of the electronic devices 112, 114, 116 may represent the same or different type of device as the DPA device 102, and/or a speaker, home theatre system, computer, mobile phone, television, communication content player, smart watch, and the like. The DPA device 102 communicates notification alerts and/or notification content to one or more chosen electronic devices over the network 111, and/or over a separated wired or wireless link therebetween. For example, an auxiliary output may be used to form a wired connection. Optionally, a Bluetooth link or other wireless link may for a direct connection wirelessly.

The DPA device 102 is configured to access the network resources 118, including web-based or network-based data, applications, and services, via the network 111. The network 111 may represent one or more of a local area network (LAN), a wide area network (WAN), an Intranet or other private network that may not be accessible by the general public, or a global network, such as the Internet or other publicly accessible network. The network 111 provides communication between the DPA device 102 and one or more network resources 118. It will be understood that, in some embodiments, the network resources 118 may represent a single entity or one or more physical or virtual servers that are configured to deliver online resources to the DPA device 102. Examples of the network resources 118 include, but are not limited to, web-based or network-based data storage services, social networking applications, shopping services, payment services, multimedia content delivery services, financial services and the like. The resources 118 may represent a Web service or a network service for an e-commerce business, financial institution, or any other commercial, noncommercial, personal, nonprofit or other entity.

As shown in FIG. 1, the DPA device 102 includes components such as one or more processors 152 (e.g., a microprocessor, microcomputer, application-specific integrated circuit, etc.), one or more local storage medium (also referred to as a memory) 154, the user interface 104 which includes one or more input circuits 105 and one or more output circuits 108, a power module 156, a component interface 158, an infrared (IR) transmitter/receiver 160 and one or more wireless transceivers 162. All of these components can be operatively coupled to one another, and can be in communication with one another, by way of one or more internal communication links, such as an internal bus.

The user interface 104 permits the user to operate the DPA device 102 for any of its intended purposes, such as administering the VR application 106, administering the NA application 110, operating software applications, electronic communication, listening to audio media, and the like. The input circuit 105 can include one or more audio input circuits, such as a microphone 164, that is configured to receive audio input or requests from the user. The output 108 can include one or more electronic devices, such as a speaker 166, that are configured to communicate notification alerts or notification content to the user. In association with the VR application 106, the user interface 104 allows the user to communicate with the DPA device 102 by receiving audio input in the form of natural language. The VR application 106 interprets the audio input received by the input circuit 105 and generates communication content, such as a voice interface to audibly respond to the user in a natural language form.

Optionally, the input and output circuits 105, 108 may each include a variety of visual, audio, and/or mechanical devices. For example, the input circuit 105 can include a visual input device, such as an optical sensor or camera, and/or a mechanical input circuit such as a keyboard, keypad, selection hard and/or soft buttons, switch, touchpad, touch screen, icons on a touch screen, a touch sensitive areas on a touch sensitive screen and/or any combination thereof. Similarly, the output circuit 108 can include a visual output circuit such as a liquid crystal display screen, touch sensitive screen, a non-touch sensitive screen, a text-only display, a smart phone display, an audio output (e.g., a speaker or headphone jack), and/or any combination thereof and/or one or more light emitting diode indicators. The output circuit 108 is integral to (e.g., within a common housing) the DPA device 102.

The memory 154 can encompass one or more memory devices of any of a variety of forms (e.g., read only memory, random access memory, static random access memory, dynamic random access memory, etc.) and can be used by the processor 152 to store and retrieve data. The data that is stored by the memory 154 can include, but need not be limited to, operating systems, applications, user collected content, and informational data. Each operating system includes executable code that controls basic functions of the device, such as interaction among the various components, communication with external devices via the wireless transceivers 162, the component interface 158, and/or the IR transmitter/receiver 160, and storage and retrieval of applications and data to and from the memory 154. Each application includes executable code that utilizes an operating system to provide more specific functionality for the communication devices, such as file system service and handling of protected and unprotected data stored in the memory 154.

The memory 154 stores various content including, but not limited to, the VR application 106, the NA application 110 and delivery attributes. The VR and NA applications 106, 110 manage one or more operations of the DPA device 102. The VR and NA applications 106, 110 include instructions accessible by the one or more processors 152 to direct the processor 152 to implement the methods, processes and operations described herein including, but not limited to, the methods, processes and operations illustrated in the Figures and described in connection with the Figures. In an alternative embodiment, the VR and NA applications 106, 110 may operate from one or more storage medium (also referred to as cloud storage).

Among other things, the NA application 110 manages operation of the processor 152 in association with identifying communication events, identifying communication content, administering notification alerts and notification content and outputting notification alerts and notification content to the electronic devices 112, 114, 116, and the output 108 (also collectively referred to herein as electric devices 108, 112, 114, 116). In accordance with the embodiment of FIG. 1, the NA application 110 directs the processor 152 to identify communication events from one or more of the electronic devices 108, 112, 114, 116, and network resources 118. For example, the NA application 110 may identify an incoming text message or phone call on the smart phone 112 or a post on a social media website on the network resources 118 as a communication event.

The processor 152 identifies communication content associated with the communication events. The communication content can include any alphanumeric textual information, audio or video information or data conveyed to or from a device during a communication event. The processor can pack, unpack, or otherwise analyze the communication event to identify the communication content therein. For example, the communication content may represent a telephone number, an email message, email address, text message, individual/business name, identifier of a source/destination device, individual, group, or business, and the like. For example, the processor can analyze an email message communication event to identify the email address of the sender, the subject heading of the email, and significant information within the body of the email message, such as dates or contact information.

The processor 152 identifies delivery attributes associated with the communication events. The delivery attributes can relate to any characteristic of interest including, but not limited to user settings, a user history of device usage, a status of the electronic devices, a time and/or date, the location or environment of the user, the proximity of the user to the DPA device 102 or electronic devices 112, 114, 116, and a presence of non-users in a predetermined range of the DPA device 102. For example, the processor may identify the communication event as a text message received by the smartphone 112 while the user is in the proximity of the smart television 114. In another example, the processor may identify the communication event as a phone call received by smart phone 112 while the user and a non-user are in a predetermined range of the DPA device.

The processor 152 identifies the availability of electronic devices 112, 114, 116 operatively connected to the DPA device 102. For example, the processor 152 can direct the transceiver 162 to transmit an availability inquiry request and listen for responses from the electronic devices 112, 114, 116. The processor 152 analyzes availability data from the responses to obtain information indicative of the availability of each electronic device. Optionally, the processor 152 analyzes data from the responses to obtain additional information about each audio device, such as the manufacturer, make, model, version of the device.

Based on the identification of delivery attributes, the processor 152 determines a priority list of the available electronic devices 108, 112, 114, 116 for communicating the notification alert and/or notification content. For example, based on delivery attributes that indicate the communication event is a text message received by the smartphone 112 and the user is in proximity to the smart television 114, the processor may determine a priority list of the electronic devices as: 1) smart TV 114; 2) smart phone 112; 3) outlet 109; and 4) wireless speaker. In this example, the smart TV 114 is ranked as the highest priority electronic device and the most likely to successfully communicate the notification alert and notification content to the user.

The processor 152 analyzes the communication event and communication content and generates a notification alert and notification content. For example, based on a communication event that was determined to be a text message, the processor may generate the notification alert as an audio communication (e.g. a ringtone, text tone, vibration, natural language communication, and the like) to be played on one or more of the available electronic devices 108, 112, 114, 116 to alert the user regarding the communication event. Additionally, the processor 152 may generate the notification content as a visual communication (e.g. pop up window, textual message, and the like) for display on one or more of the available electronic devices 112, 114. Optionally, the processor 152 directs the transceiver 162 to access the network resources 118 through the network 111 in connection with generating the notification content. For example, the processor 152 may access the network resources 118 to obtain contact information associated with the sender of a text message received.

Among other things, the VR application 106 manages operation of the processor 152 in association with receiving user requests and outputting a response to the DPA device 102 and/or the electronic devices 108, 112, 114, 116. The input circuit 105 of the user interface 104 receives a user request. The processor 152 analyzes the user request and generates a response. Optionally, the processor 152 directs the transceiver 162 to access the network resources 118 through the network 111 in connection with generating the response. For example, based on information available in the memory 154 and/or through the network 110 from the network resources 118, the processor 152 can output an informational answer, such as weather conditions or the score of a sporting event, in the form of natural language audio content or by performing a task.

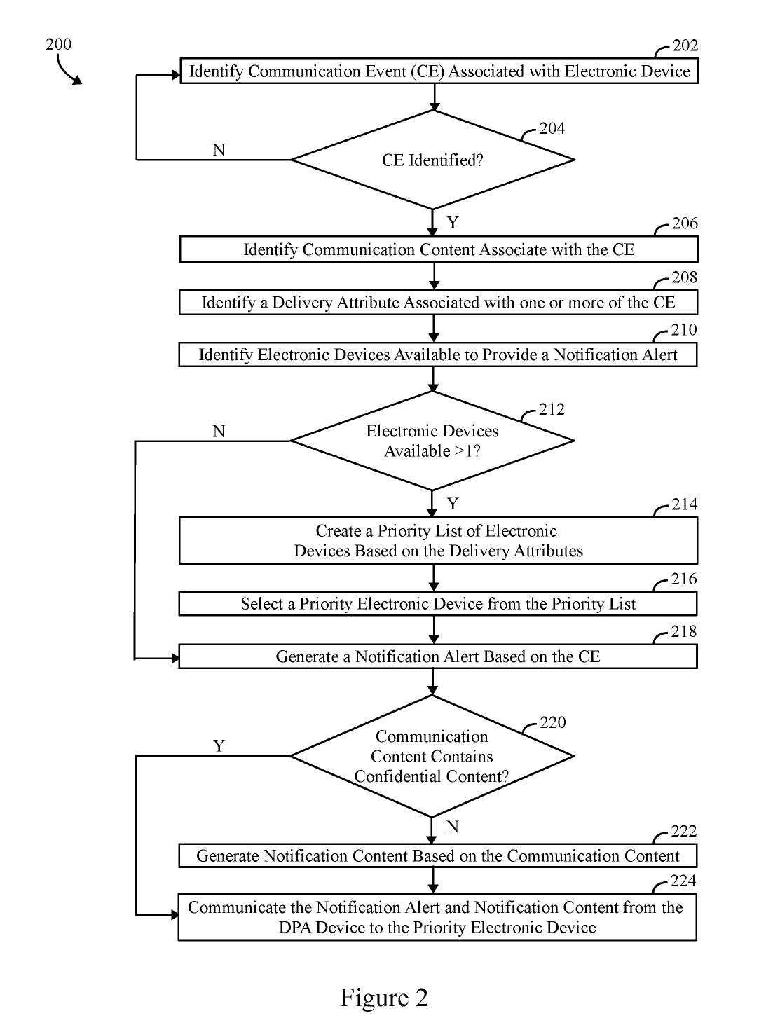

FIG. 2 illustrates a process 200 for selecting an electronic device based on delivery attributes in accordance with embodiments herein. The operations of FIG. 2 are carried out by the one or more processors 152 of the DPA device 102 in response to execution of instructions, such as in the NA application 110 and/or other applications stored in the memory 154.

At 202, the processor 152 identifies communication events associated with the electronic devices 112, 114, 116, and/or the network resource 118. For example, the communication event may represent an incoming or outgoing text message, email message, FaceTime call, audio call, or any other type of communication. At 204, when the processor 152 identifies one or more communication events, the flow advances to 206. Otherwise, flow moves back to 202 for the processor 152 to continue to identifying communication events.

When the flow advances to 206, the processor 152 identifies communication content associated with the communication event. For example, the processor 152 analyzes any textual information, audio information or data associated with the communication event (e.g. telephone number, an email message, email address, text message, individual/business name, identifier of a source/destination device, individual, group, or business, and the like).

At 208, the processor 152 identifies delivery attributes associated with the communication event. The delivery attributes can include any characteristic of interest or parameter associated with the communication event. For example, the delivery attribute may also be a user history of usage patterns for an associated user. The user history may indicate that the associated user primarily receives notification alerts through the user's smart phone. The processor 152 can update the user history on a periodic basis, such as after each notification event. Additionally or alternatively, the delivery attribute may include a status condition of each electronic device 108, 12, 114, 116. For example, the processor 152 can direct the transceiver 162 to transmit a status condition request and listen for responses from electronic devices 108, 112, 114, 116. The processor 152 can analyze responsive status condition data to obtain information indicative of the status of each electronic device, such as on, off, restricted, sleep, over-heated or standby.

Optionally, the processor 152 can send a signal to one of the electronic devices 108, 112, 114, 116 to change the status. In another example, the delivery attribute may include a time or date. In yet another example, the delivery attribute may include the location or environment of the associated user. For example, the DPA device 102 or electronic devices 108, 112, 114, 116 can use visual devices motion sensors, wireless identifying devices, audio monitoring, and the like to determine the location or environment of the user. The delivery attribute may include the presence of non-users within a predetermined range of the DPA device 102. Similar to the above, the DPA device 102 or electronic devices 108, 112, 114, 116 can use visual devices motion sensors, wireless tracking devices, audio monitoring, and the like to determine that non-users are present within the same room as the user. Notification alerts and notification content may be directed to a different electronic device when non-users are present.

In one illustrative embodiment, the user may be a parent receiving a notification alert with mature or confidential notification content. The non-user may be a child detected to be present in the same room as the parent. Accordingly, the notification alert and notification content may be directed to an electronic device only accessible by the parent, such as the user's smart phone or headphones, to prevent the child from receiving the mature or confidential notification content.

At 210, the processor 152 identifies the availability of electronic devices 108, 112, 114, 116. For example, the processor 152 can direct the transceiver 162 to transmit an availability inquiry request and listen for responses from the electronic devices 108, 112, 114, 116. The processor 152 analyzes availability data from the responses to obtain information indicative of the availability of each electronic device. Optionally, the processor 152 analyzes data from the responses to obtain additional information about each audio device, such as the manufacturer, make, model, version of the device.

At 212, when the processor 152 identifies the availability of more than one electronic devices, the flow advances to 214. For example, the processor may identify the smart phone 112, the smart television 114, the wireless speaker 116, and the output 108 as available electronic devices. Otherwise, when the processor identifies a single electronic device, flow advances to 218 because there is no need to create a priority list. For example, the processor may only identify the output 108 as an available electronic device.

At 214, the processor 152 determines a priority list of the available electronic devices 108, 112, 114, 116 based on at least one of the delivery attributes. For example, a delivery attribute that indicates that the user is located in close proximity to the DPA device 102, may raise the priority of the output 108 of the DPA device 102. In contrast, if the delivery attribute indicates a user history for a preferred electronic device, such as the smart phone 112, the priority of the smart phone 112 may raise in priority. If the delivery attribute indicates that one or more of the electronic devices 108, 112, 114, 116 have a status of OFF, the priority of the circuits may be lowered. If the delivery attribute indicates that non-users are present in a particular location, such as in the same room as the user, the priority of the electronic devices may be raised or lowered accordingly. For example, the priority of a television may be lowered, and the priority of a smart phone may be raised. If the delivery attribute indicates a time of day or date, the priority of the electronic devices may be raised or lowered. For example, if the delivery attribute indicates a time of 7 pm on a Saturday in July, the priority of electronic devices near the outdoor pool may be raised, and the priority of other electronic devices lowered.

At 216, the processor 152 selects a priority electronic device from the priority list. For example, the processor 152 can select the electronic device 108, 112, 114, 116 that is determined to be the highest priority on the priority list. Alternatively, the processor can select the electronic device 108, 112, 114, 116 that is determined to be a different priority on the priority list, such as the second highest priority. For example, the priority list may indicate that the smart television 114 is the highest priority electronic device, but due to mature or confidential content contained within the notification content, select a lower priority on the list, such as smart phone 112.

At 218, the processor 152 generates a notification alert based on the communication event. Based on information available in the memory 154 and/or through the network 111 from the network resources 118, the processor 152 can output the notification alert in the form of an textual, audio or visual content, including but not limited to text communication, audio tone, natural language communication, an image, a light, and the like. For example, the processor 152 can generate a notification alert that displays a pop-up window or textual message on the screen of the smart television 114 based on a communication event. In another example, the processor 152 can generate a notification alert that produces an audio tone or natural language communication on the speaker 166 of the DPA device 102.

At 220, when the processor 152 identifies confidential content within the communication content, the flow advances to 224. Otherwise the flow advances to 222. The identification of confidential content may be performed in various manners. For example, the processor may search for keywords or key phrases, commonly used in association with confidential information, such as “Attorney-Client Privileged”, “Credit Card #”, “Social Security #”, and the like. Additionally or alternatively, the processor may identify mature content within the communication content. For example, the mature content may be identified based on ratings data provided with the content.

At 222, the processor 152 generates notification content based on the communication content associated with the communication event. The notification content may be a synopsis, summary, or portion of the communication content configured to provide the user with a preview of the complete communication content. For example, the notification content can include the subject line and contact information of the sender of an email message. Optionally, the notification content can include the complete communication content. Based on information available in the memory 154 and/or through the network 111 from the network resources 118, the processor 304 can output notification content in the form of textual, audio or visual content, including, but not limited to text communication, audio tone, natural language communication, an image, and the like.

At 224, the DPA device 102 communicates the notification alert and if generated at 222 the notification content to the selected electronic device over one or more wired or wireless medium, such as the transceiver 162, and/or the IR transmitter/receiver 160. The content and nature of the notification alert and/or notification content may vary based on various factors. For example, the notification alert and notification content may be conveyed in accordance with a Bluetooth protocol. Optionally, the notification alert and notification content may be conveyed in accordance with various wireless protocols, such as 802.11, wireless local area network (WLAN), Wi-Fi protected access (WPA), wired equivalent privacy (WEP), Wi-Fi, wireless broadband and the like. As other examples, the responses may be conveyed in accordance with various communications protocols, such as a hypertext transfer protocol (HTTP), Internet relay chat (IRC) and the like.

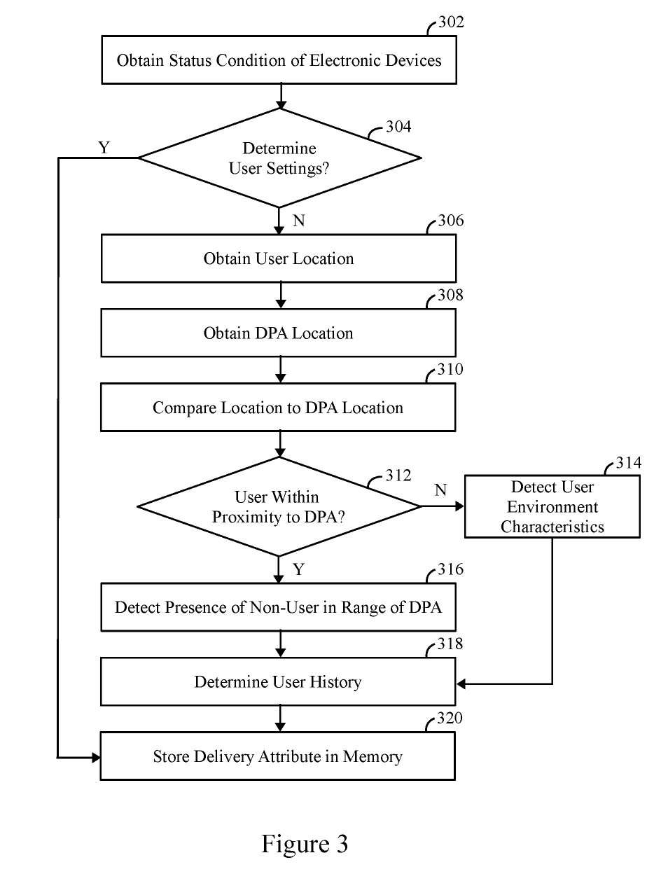

FIG. 3 illustrates a process 300 for determining a delivery attribute based on various characteristics of interest in accordance with an embodiment herein. At 302, under control of the NA application one or more processors obtain the status condition of the electronic devices 108, 112, 114, 116. For example, the processor 152 can direct the transceiver 162 to transmit a status condition request and listen for responses from electronic devices 108, 112, 114, 116. The processor 152 can analyze responsive status condition data to obtain information indicative of the status of each electronic device (e.g. smart phone 112 is in restricted mode, the smart tv 114 is on, the wireless speaker 116 is off, and the DPA output 108 is on).

At 304, the one or more processors 152 determine if any user settings are stored in the memory 154 to be characterized as a delivery attribute. When the processor 152 determines user settings are stored, the flow advances to 320. Otherwise, the flow advances to 306 to continue the process of determining delivery attributes. The user settings may be entered or modified by the user into the DPA using the input 105 of the user interface 104, and stored in the memory 154. For example, the user may request a user setting be entered by stating, “Send all text messages to the TV,” or “Announce all notifications on the stereo.”

At 306, the one or more processors 152 obtain location information of the user as a characteristic of interest. For example, a GPS module within one of the electronic devices being used by the user, such as the smart phone 112, may be utilized to obtain GPS coordinates. Additionally or alternatively, the electronic device may determine a location relative to other sensory inputs, such as when the electronic device is within range of a home router Wi-Fi network. Additionally or alternatively, the electronic device may determine location based on image detection through the camera (e.g., the electronic device recognizes from an image capture, that the device is in the kitchen, in the garage, etc.).

At 308, the one or more processors 152 obtains location information of the DPA device 12 as a characteristic of interest. For example, a GPS module within the DPA device 102 may be utilized to obtain GPS coordinates. Additionally or alternatively, the DPA device 102 may determine a location relative to other sensory inputs, such as when the DPA device 102 is within range of a home router Wi-Fi network. Additionally or alternatively, the DPA device 102 may determine location based on input from the user.

At 310, one or more processors 152 compare the location of the user with the location of the DPA device 102 to determine if the user is within a predetermined area or proximity of the DPA device 102. For example, when utilizing GPS coordinates, the processor(s) 152 may determine when the user is closer than a predetermined distance (e.g. 15 ft. or 30 ft.) from the DPA device 102. Optionally, the processor(s) 152 may determine when the user and the DPA device 102 are within the boundaries of an area in a house (e.g., kitchen, garage, backyard, or study area). Optionally, the processor(s) 152 may determine when user and the DPA device 102 are within a predetermined range of a reference coordinate point. Optionally, the predetermined area may correspond to a Wi-Fi range of a home router, prerecorded images of areas within the home, and the like.

At 312, when the one or more processor 152 determine the user is within the predetermined proximity to the DPA device 102, the flow advances to 316. Otherwise the flow advances to 314. For example, the user may be more than 20 feet, 30 feet, etc. from the DPA device 102. When the user is beyond a predetermined range from the DPA device 102, the processor 152 may determine that the user is no longer able to hear an audio output from the DPA device 102. Additionally or alternatively, the predetermined range characteristic of interest may be utilized to adjust the delivery attribute. For example, the delivery attribute may relate to a volume utilized when outputting a notification alert. For example, when the user is 5 feet away from the DPA device 102, the processor 152 may output the notification alert at a low or medium volume. When the user is 20 to 30 feet away from the DPA device 102, the processor 152 may output the notification alert at a high volume.

At 314, one or more processors 152 detect characteristics of the environment where the user is located. For example, the user may be in an environment that distracts the user or impedes receipt of the notification, such as an entertainment venue or work environment. The environment of the user may be detected using a GPS module within one of the electronic devices being used by the user, such as the smart phone 112. Additionally or alternatively, the electronic device may detect the environment using sensory inputs, such as when a microphone of the smart phone 112 detecting loud ambient noise. Additionally or alternatively, the electronic device may determine the environment based on image detection through the camera (e.g., the electronic device recognizes from an image capture, that the electronic device is in the kitchen, in the garage, etc.).

At 316, one or more processors 152 detect the presence of non-users within a predetermined range of the DPA device 102. For example, the processor 152 may determine that multiple family members are present in a room (e.g. a living room) where the DPA device 102 is located. A parent may receive a communications event on the smart phone 112, where the communications event has a delivery attribute indicating that the communications content is work related, personal or confidential (e.g. a text from a coworker, a voicemail from a financial advisor, a confidential email from a client, etc.). When the communication event is work related, the processor 152 may determine that the notification alert associated with the communications event should be directed to a work-related electronic device (e.g. a smart phone issued by a business or designated for work-related communications). When the communications event is personal, the processor 152 may determine that the notification alert should be limited to very general cursory information concerning the communications event (e.g. “You have received a personal text/email/voicemail”).

At 318, one or more processors 152 determine a user history as a characteristic of interest. Under control of the NA application, the processor 152 can analyze past interactions and usage patterns for the user. For example, the user history may indicate that the user is typically located in a work environment during weekdays and can receive notification alerts on the smart phone 112. The processor 152 can update the user history on a periodic basis, such as after each notification alert. Optionally, the user history may retain user device usage patterns for multiple associated users, such as multiple users within a household.

At 320, one or more processors 152 store the delivery attributes associated with the communication event in the memory 154 for use in the process 200 to create a priority list of the electronic devices 108, 112, 114, 116 based on the delivery attributes.

As will be appreciated by one skilled in the art, various aspects may be embodied as a system, method or computer (device) program product. Accordingly, aspects may take the form of an entirely hardware embodiment or an embodiment including hardware and software that may all generally be referred to herein as a “circuit,” “module” or “system.” Furthermore, aspects may take the form of a computer (device) program product embodied in one or more computer (device) readable storage medium(s) having computer (device) readable program code embodied thereon.

Any combination of one or more non-signal computer (device) readable medium(s) may be utilized. The non-signal medium may be a storage medium. A storage medium may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random access memory (RAM), a dynamic random access memory (DRAM), a read-only memory (ROM), an erasable programmable read-only memory (EPROM or Flash memory), a portable compact disc read-only memory (CD-ROM), an optical storage device, a magnetic storage device, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of network, including a local area network (LAN) or a wide area network (WAN), or the connection may be made through other devices (for example, through the Internet using an Internet Service Provider) or through a hard wire connection, such as over a USB connection. For example, a server having a first processor, a network interface, and a storage device for storing code may store the program code for carrying out the operations and provide this code through its network interface via a network to a second device having a second processor for execution of the code on the second device.

Aspects are described herein with reference to the figures, which illustrate example methods, devices and program products according to various example embodiments. These program instructions may be provided to a processor of a general purpose computer, special purpose computer, or other programmable data processing device or information handling device to produce a machine, such that the instructions, which execute via a processor of the device implement the functions/acts specified. The program instructions may also be stored in a device readable medium that can direct a device to function in a particular manner, such that the instructions stored in the device readable medium produce an article of manufacture including instructions which implement the function/act specified. The instructions may also be loaded onto a device to cause a series of operational steps to be performed on the device to produce a device implemented process such that the instructions which execute on the device provide processes for implementing the functions/acts specified.

The units/modules/applications herein may include any processor-based or microprocessor-based system including systems using microcontrollers, reduced instruction set computers (RISC), application specific integrated circuits (ASICs), field-programmable gate arrays (FPGAs), logic circuits, and any other circuit or processor capable of executing the functions described herein. Additionally or alternatively, the units/modules/controllers herein may represent circuit modules that may be implemented as hardware with associated instructions (for example, software stored on a tangible and non-transitory computer readable storage medium, such as a computer hard drive, ROM, RAM, or the like) that perform the operations described herein. The above examples are exemplary only, and are thus not intended to limit in any way the definition and/or meaning of the term “controller.” The units/modules/applications herein may execute a set of instructions that are stored in one or more storage elements, in order to process data. The storage elements may also store data or other information as desired or needed. The storage element may be in the form of an information source or a physical memory element within the modules/controllers herein. The set of instructions may include various commands that instruct the units/modules/applications herein to perform specific operations such as the methods and processes of the various embodiments of the subject matter described herein. The set of instructions may be in the form of a software program. The software may be in various forms such as system software or application software. Further, the software may be in the form of a collection of separate programs or modules, a program module within a larger program or a portion of a program module. The software also may include modular programming in the form of object-oriented programming. The processing of input data by the processing machine may be in response to user commands, or in response to results of previous processing, or in response to a request made by another processing machine.

It is to be understood that the subject matter described herein is not limited in its application to the details of construction and the arrangement of components set forth in the description herein or illustrated in the drawings hereof. The subject matter described herein is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items.

It is to be understood that the above description is intended to be illustrative, and not restrictive. For example, the above-described embodiments (and/or aspects thereof) may be used in combination with each other. In addition, many modifications may be made to adapt a particular situation or material to the teachings herein without departing from its scope. While the dimensions, types of materials and coatings described herein are intended to define various parameters, they are by no means limiting and are illustrative in nature. Many other embodiments will be apparent to those of skill in the art upon reviewing the above description. The scope of the embodiments should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects or order of execution on their acts.

What is claimed is:

1. A method, comprising:
under control of one or more processors configured with executable instructions;
identifying a communication event and a delivery attribute associated with the communication event;
identifying electronic devices available to provide a notification alert;
selecting at least one of the electronic devices based on the delivery attribute;
generating the notification alert based on the communication event; and
communicating the notification alert to the at least one of the electronic devices selected.

2. The method of claim 1, wherein at least a portion of the identifying, selecting, generating and communicating is performed by a digital personal assistant (DPA) device.

3. The method of claim 2, further comprising determining the delivery attribute based on a presence of non-users within a predetermined range of the DPA device.

4. The method of claim 2, further comprising determining the delivery attribute based on a characteristic of an environment that the user is located, or proximity of the user to the DPA device.

5. The method of claim 2, further comprising determining the delivery attribute based on a characteristic of a user environment that impedes detection of the notification alert.

6. The method of claim 2, further comprising determining the delivery attribute based on one or more of a user history or user settings maintained at the DPA device.

7. The method of claim 2, further comprising determining the delivery attribute based on status conditions of the electronic devices.

8. The method of claim 2, further comprising determining a priority list of the electronic devices based on the delivery attribute, and selecting a priority electronic device from the priority list based on the delivery attribute.

9. A digital personal assistant (DPA) device, comprising:
a processor;
a user interface;
a memory having executable instructions accessible by the processor;
wherein, responsive to execution of the instructions, the processor to:
identify a communication event and a delivery attribute associated with the communication event;
identify electronic devices available to provide a notification alert;
select at least one of the electronic devices based on the delivery attribute;
generate the notification alert based on the communication event; and
communicate the notification alert from the DPA device to the at least one of the electronic devices.

10. The device of claim 9, wherein the executable instructions are executable by the processor to determine the delivery attribute based on a characteristic of an environment that the user is located, or proximity of the user to the DPA device.

11. The device of claim 9, wherein the executable instructions are executable by the processor to determine the delivery attribute based on a characteristic of a user environment that impedes detection of the notification alert.

12. The device of claim 9, wherein the executable instructions are executable by the processor to determine the delivery attribute based on a user history or user settings maintained at the DPA device.

13. The device of claim 9, wherein the executable instructions are executable by the processor to determine the delivery attribute based on status conditions of the electronic devices.

14. The device of claim 9, wherein the executable instructions are executable by the processor to determine a priority list of the electronic devices based on the delivery attribute, and select a priority electronic device from the priority list based on the delivery attribute.

15. A digital personal assistant (DPA) device comprising executable code to:
identify a communication event and a delivery attribute associated with the communication event;
identify a delivery attribute associated with one or more of the communication events;
identify electronic devices available to provide a notification alert;
select at least one of the electronic devices based on the delivery attribute;
generate the notification alert based on the communication event; and
communicate the notification alert from the DPA device to the at least one of the electronic devices.

16. The device of claim 15, further comprising executable code to determine the delivery attribute based on a characteristic of an environment that the user is located, or proximity of the user to the DPA device.

17. The device of claim 15, further comprising executable code to determine the delivery attribute based on a characteristic of a user environment that impedes detection of the notification alert.

18. The device of claim 15, further comprising executable code to determine the delivery attribute based on one or more of a user history or user settings maintained at the DPA device

19. The device of claim 15, further comprising executable code to determine the delivery attribute based on status conditions of the electronic devices.

20. The device of claim 15, further comprising executable code to determine a priority list of the electronic devices based on the delivery attribute and select a priority electronic device from the priority list based on the delivery attribute.
